(19) United States
(12) Patent Application Publication
(10) Pub. No.: US 2009/0066621 A1
(43) Pub. Date: Mar. 12, 2009

(54) LIQUID CRYSTAL DISPLAY DEVICE

(75) Inventors: Yoshihisa Iwamoto, Yokohama-shi (JP); Katsumi Inuzuka, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Stanley Electric Co., Ltd., Tokyo (JP)

(21) Appl. No.: 12/205,001

(22) Filed: Sep. 5, 2008

(30) Foreign Application Priority Data
Sep. 7, 2007 (JP) 2007-232630

(51) Int. Cl. G09G 3/36

(52) U.S. Cl. 345/88

(57) ABSTRACT

A liquid crystal display device includes: a liquid crystal display unit including a plurality of display units each switching between bright display and dark display; a backlight having a light source of a plurality of colors for making light emitted from the light source be incident upon the liquid crystal display unit; and a drive unit for performing field sequential driving through synchronization of the liquid crystal display unit and backlight, wherein the drive unit controls a state of bright/dark display of the liquid crystal display unit to realize a display pattern corresponding to each subframe obtained by dividing a frame into a plurality of subframes, and controls an emission state of the backlight to turn on the backlight of emission color corresponding to a display pattern of an arbitrary first subframe from some timing in the first subframe to some timing in a second subframe immediately after the first subframe.

### CROSS REFERENCE TO RELATED APPLICATION

This application is based on and claims priority of Japanese Patent Application No. 2007-232630 filed on Sep. 7, 2007, the entire contents of which are incorporated herein by reference.

### BACKGROUND OF THE INVENTION

A) Field of the Invention

The present invention relates to a liquid crystal display device, and more particularly to a liquid crystal display device under field sequential (FS) driving.

B) Description of the Related Art

A liquid crystal display device capable of segment display or segment display together with dot matrix display is used in a display unit or the like of a vehicle mounted information display device or a car audio apparatus. One of liquid crystal display devices capable of color segment display has the structure that white backlight is radiated to a liquid crystal display unit formed with color filters.

Disadvantages of a liquid crystal display device with color filters are a necessity of a process of forming color filters on a glass substrate of a liquid crystal display unit, a limit of each segment color to colors of the color filters, and the like.

Another liquid crystal display device capable of color segment display is a device under so-called field sequential (FS) driving A liquid crystal display device of this type does not have color filters of a liquid crystal display unit, but realizes desired color display by time sequentially switching emission color, using a multicolor backlight constituted of a multicolor light emitting diode (LED) capable of emission of, e.g., red, green and blue (RGB).

With reference to FIG. 14, description will be made on a specific example of a conventional FS driving method. FIG. 14 is a timing chart illustrating timings of each segment input signal and backlight emission. It is assumed that a liquid crystal display unit is a normally black type that light is transmitted in an on-state and not transmitted in an off-state.

One frame representative of a time unit of displaying one image is constituted of three subframes SB1 to SB3 during which the backlight emits R, G and B colors. For example, one frame time is 16.7 ms in conformity with the NTSC specifications, and a time of each subframe is 5.57 ms.

A drive waveform applied to a liquid crystal display unit is, e.g., a rectangular wave, and its drive frequency is set to have one or more periods in one subframe, and its amplitude (drive voltage) during an on/off state is adjusted to allow the liquid crystal display unit to display a bright/dark state corresponding to an input signal.

Generally, a liquid crystal display unit has a slower response to an applied voltage than that of a backlight, and it is necessary to provide a blank time not turning on the backlight until the liquid crystal display unit responds to some degree.

FIG. 15 shows an example of measurements of an electrooptical fall response when one segment of a normally black type liquid crystal display unit changes from bright display to dark display. An upper portion of the ordinate represents a transmissivity, a lower portion of the ordinate represents a potential of a drive waveform between upper and lower electrodes of the segment, and the abscissa represents a lapse time.

It can be seen that even if a drive voltage lowers from a voltage V not smaller than a threshold value to 0 V, a transmissivity does not lower sufficiently at once. If the backlight of designated color is tuned on in a subframe in the state that the transmissivity does not lower sufficiently, color purity lowers because color emission in this segment to be extinguished leaks. It is therefore necessary to provide a blank time not turning on the backlight, until the transmissivity lowers sufficiently.

It is therefore necessary to set a period until the transmissivity lowers sufficiently to a blank time not turning on the backlight. For example, if a fall response time of the liquid crystal cell changing from bright display to dark display is about 3 ms, a blank time is required to be about 2.5 ms, preferably about 3 ms.

Reverting to FIG. 14, description will be made further. A blank time B is provided immediately after switching each subframe. A backlight emission time L is set to a period after the blank time B to each subframe end time, to turn on the backlight of color corresponding to each subframe.

If a subframe operation is performed at speed not recognized by human eyes (e.g., about 16.7 ms/frame, about 5.57 ms/subframe, and about 3 ms/blank time), color display suppressing flicker can be realized as intended. In the example shown in FIG. 14, a segment 1 is recognized as yellow which is mixture color of R and G, a segment 2 is recognized as magenta which is mixture color of R and B, and a segment n is recognized as green G, by human eyes.

With the above-described FS driving method (hereinafter called a normal FS driving method in order to distinguish it from a color break-less FS driving method), however, there may arise a phenomenon called color break in which an image of each subframe not recognized by human eyes in a normal state is separated and observed by human eyes. This phenomenon occurs particularly when an environment of an observer is dark, in a state that visual axes of an observer depart from the display unit, in a state that vibrations are applied to the display unit (e.g., in an environment in a vehicle) and in other states. It can be said that this phenomenon provides a display state not so much preferable in terms of human psychological factors.

The color break phenomenon occurs clearly particularly in a white display area. Therefore, the color break phenomenon is considered to be recognized remarkably if an emission operation is performed in a plurality of subframes for one segment by the normal FS driving method. i.e., in a mixture color display state of white, yellow or magenta.

As a method of reducing the color break phenomenon, methods have been proposed such as a method of inserting a white display subframe in one frame. These methods cannot, however, eliminate the color break phenomenon.

One of the present inventors and their colleagues have proposed an FS driving method capable of eliminating the color break phenomenon (this method is hereinafter called the color break-less FS driving method in order to distinguish it from the above-described normal FS driving method) in Japanese Patent Publication No. 3894323, the entire contents of which are incorporated herein by reference.

A fundamental concept of this driving method is to eliminate the color break phenomenon by using not only primary colors (R, G and B) but also mixture colors (such as white and orange) as backlight emission colors in one subframe, and performing emission of backlight only in one subframe for each segment.

With reference to FIG. 16, a specific example of the color break-less FS driving method will be described. FIG. 16 is a timing chart illustrating timings of each segment input signal and a backlight emission state. It is assumed that the liquid crystal display unit is a normally black type.

In this example, a backlight emission color is white for a subframe 1, orange for a subframe 2, and blue for a subframe 3. With this driving method, the number of colors allowable in each frame is M+1 colors including black added to M emission colors corresponding to the number of subframes.

Since backlight emission color can be changed for each fame, it is obvious that the number of display colors can be increased considerably more than the above-described normal FS driving method, if the operation of the liquid crystal display unit is binary bright/dark display.

In this example, one frame of 16.7 ms is divided into three subframes of the same time duration. A time duration of each subframe may be changed in accordance with emission color of the backlight. Namely, even if subframes have different time durations, an operation is possible.

In this example, a segment 1 displays white, a segment 2 displays black, and a segment n displays orange. Similar to the normal FS driving method, a blank time B of about 3 ms for awaiting an electrooptical response of the liquid crystal display unit is provided immediately after subframe switching. A backlight emission time L is set to a period after the blank time B to the subframe end time to turn on the backlight of color corresponding to the subframe.

With these operations, it becomes possible to realize color display without flicker and color break as intended when viewed externally.

Both the normal FS driving method and color break-less method provide a blank time in order to avoid unnecessary color mixture between subframes. For example, as in the above-described example, the frame of 16.7 ms is divided into three subframes having the same time duration of 5.57 ms and the blank time is set to about 3 ms. In this case, a backlight emission time in each subframe is about 2.57 ms, and the emission time is shorter than a half of the subframe time.

For example, as compared with a liquid crystal display device using color filters and being able to always turn on a backlight, a liquid crystal display device under FS driving is more difficult to increase its display luminance. Techniques of increasing a display luminance have been long desired for FS driving.

If white display is performed under the conditions of the above-described example, for example, by a normal FS driving method, a backlight emission time can be prolonged to about 7.71 ms in one frame, as a total sum of three subframes for RGB emission. However, if the color break-less FS driving method is used, a backlight is turned on only in one subframe even for color mixture display. It has been long desired to provide techniques of increasing a display luminance, particularly for the color break-less FS driving method.

### SUMMARY OF THE INVENTION

An object of the present invention is to provide a liquid crystal display device under FS driving with an improved display luminance.

According to one aspect of the present invention, there is provided a liquid crystal display device comprising: a liquid crystal display unit including a plurality of display units each switching between bright display and dark display; a backlight having a light source of a plurality of colors for making light emitted from the light source be incident upon the liquid crystal display unit; and a drive unit for performing field sequential driving through synchronization of the liquid crystal display unit and backlight, wherein the drive unit controls a state of bright/dark display of the liquid crystal display unit to realize a display pattern corresponding to each subframe obtained by dividing a frame into a plurality of subframes, and controls an emission state of the backlight to turn on the backlight of emission color corresponding to a display pattern of an arbitrary first subframe from some timing in the first subframe to some timing in a second subframe immediately after the first subframe.

For example, the backlight of emission color corresponding to the display pattern of the first subframe is turned on in the first subframe, and continues to be turned on in the second subframe immediately thereafter, by prolonging to the second subframe.

Further, for example, even if the backlight of emission color corresponding to the display pattern of the first subframe is not turned on in the first subframe, it is turned on in the second subframe immediately after the first subframe. For example, if a response speed of liquid crystal is slow because of a low temperature, it may occur a case in which liquid crystal does not respond sufficiently (a fall from bright display to dark display is insufficient) until the end time of the subframe and the backlight of emission color corresponding to the display pattern of the first subframe cannot be turned on. In such a case, the backlight of emission color corresponding to the display pattern of the first subframe is turned on in the second subframe immediately thereafter to ensure a backlight emission time.

### BRIEF DESCRIPTION OF THE DRAWINGS

FIG. 1 is a schematic block diagram of a liquid crystal display device according to a first embodiment of the present invention.

FIG. 2A is a schematic perspective view of an NWTN mode liquid crystal display unit, FIG. 2B is a schematic cross sectional view showing an example of the structure of a glass substrate, and FIG. 2C is a schematic cross sectional view showing another example of the structure of a glass substrate.

FIG. 3 is a schematic perspective view of a two-layer TN mode liquid crystal display unit.

FIG. 4 is a schematic perspective view of a VA mode liquid crystal display unit.

FIGS. 5A and 5B are graphs showing electrooptical transient response waveforms at switching from dark display to bright display and at switching from bright display to dark display, respectively.

FIG. 6 is a graph showing rise/fall electrooptical transient response characteristics of a two-layer TN liquid crystal display unit in correspondence with timings of one subframe

FIG. 7 is a timing chart showing timings of input signals to segment display units and emission timing of a backlight by a driving method of a second embodiment.

FIG. 8 is a timing chart showing timings of input signals to segment display units and emission timing of a backlight by a driving method of a third embodiment.

FIG. 9 is a timing chart showing timings of driving waveforms applied to common (scan line) electrodes and emission timing of a backlight by a driving method of a fourth embodiment.

FIGS. 10A and 10B are graphs showing rise response time temperature dependency and fall response time temperature dependency of an NWTN unit, a two-layer TN unit and a VA unit, respectively.

FIG. 11 is a graph showing rise response lag time temperature dependency of an NWTN unit, a two-layer TN unit and a VA unit.

FIGS. 12A and 12B are tables showing a list of drive parameters according to fifth and sixth embodiments.

FIG. 13 is a schematic diagram of a liquid crystal display unit according to a seventh embodiment.

FIG. 14 is a timing chart showing timings of input signals to segment display units and backlight emission by a conventional normal FS driving method.

FIG. 15 is a graph showing an electrooptical fall response during switching from bright display to dark display of one segment of a normally black type liquid crystal display unit.

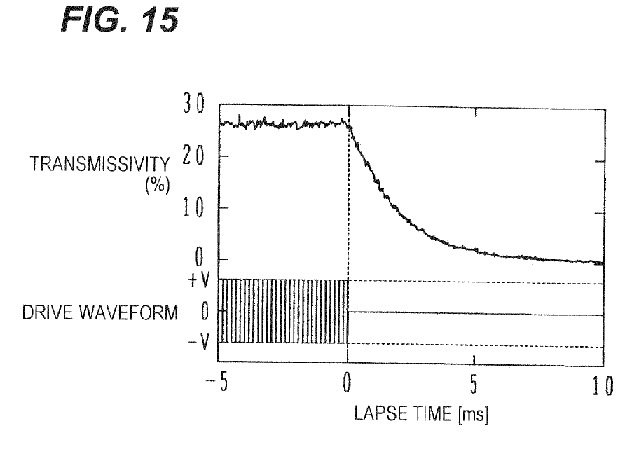

FIG. 16 is a timing chart showing timings of input signals to segment display units and backlight emission by a conventional color break-less FS driving method.

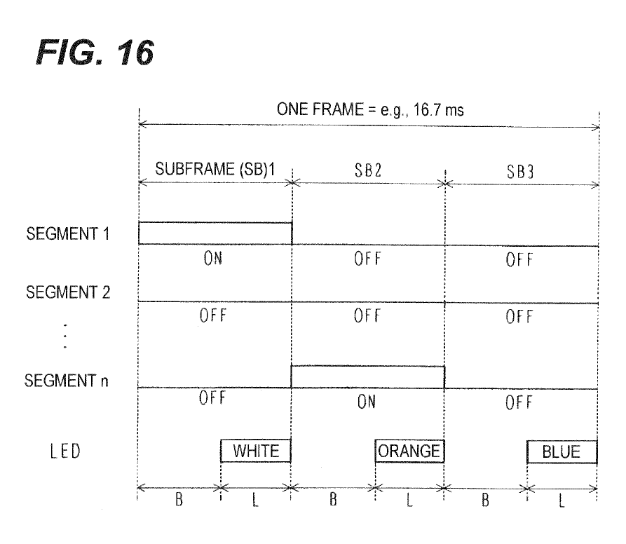

FIG. 17 is a timing chart showing timings of drive waveforms applied to common (scan line) electrodes and backlight emission by a conventional FS driving method of multiplex driving.

### DESCRIPTION OF THE PREFERRED EMBODIMENTS

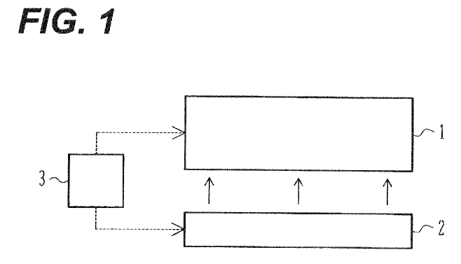

First, with reference to FIG. 1 description will be made on a liquid crystal display device according to the first embodiment of the present invention. FIG. 1 is schematic diagram showing a liquid crystal display of the embodiment. The liquid crystal display device is constituted of a liquid crystal display unit 1, a multicolor backlight 2 and a drive unit 3. The backlight 2 is disposed on the back of the liquid crystal display unit 1, and includes a multicolor light emitting diode (LED) capable of, for example, red, green and blue (RGB) emission. The drive unit 3 synchronously drives the liquid crystal display unit 1 and multicolor backlight 2 at desired timings to obtain color display of multiplex field sequential (FS) driving.

The present inventors manufactured liquid crystal display units 1 operating in the following three operation modes, and evaluated their electrical characteristics.

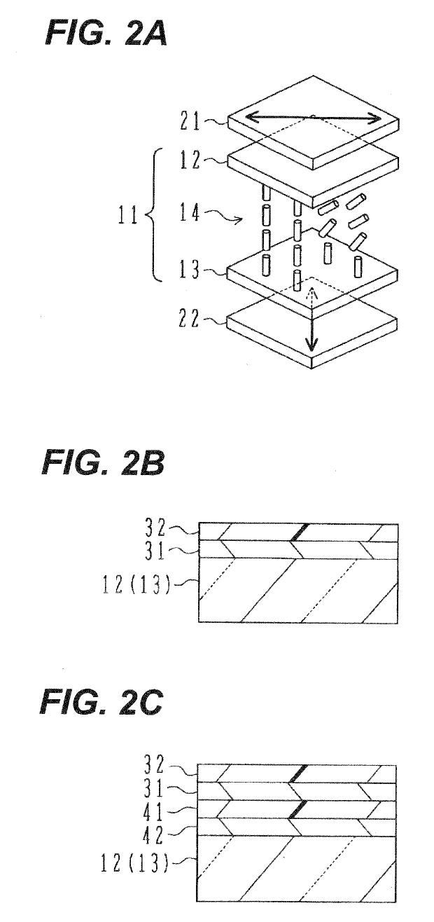

With reference to FIGS. 2A to 2C, description will be made on a normally white (NW) twisted nematic (TN) mode liquid crystal display unit. FIG. 2A is a schematic perspective view of an NWTN mode liquid crystal display unit. A liquid crystal cell 11 is constituted of upper and lower glass substrates 12 and 13 and a liquid crystal layer 14 formed between.

As shown in FIG. 2B, a transparent electrode 31 having a pattern corresponding to a display pattern is disposed on the inner surface of each of the glass substrates 12 and 13 of the liquid crystal cell, and a horizontal alignment film 32 is formed on the transparent electrode. Upper and lower horizontal alignment films 32 are subjected to a rubbing process to align liquid crystal molecules at left twist of 90° between upper and lower substrates.

The liquid crystal layer 14 is formed by making a space between the upper and lower horizontal alignment films 32 be filled with liquid crystal material of Δε>0 added with left twist chiral material. A thickness of the liquid crystal layer 14, i.e., a cell thickness is set to about 2 μm and a ratio d/p of the liquid crystal cell thickness d and a liquid crystal material twist pitch p is set to about 0.35. A retardation Δnd, a product of the liquid crystal material birefringence Δn and the cell thickness d, is set to about 446 nm. The rubbing direction is adjusted in such a manner that a molecule alignment direction at the center of the liquid crystal layer in a thickness direction is a 6 o'clock direction in the device in-plane as the liquid crystal display unit is viewed along a normal direction.

The liquid crystal cell 11 is disposed between an upper polarizer 21 and a lower polarizer 22 cross-Nicol disposed. An absorption axis of each of the polarizers 21 and 22 is set perpendicular to a rubbing direction of the adjacent substrate of the liquid crystal cell 11. The polarizers 21 and 22 are made of, for example, SKN18243T manufactured by Polatechno Co., Ltd.

In order to improve visual angle characteristics and the like of a liquid crystal display unit, a black mask film is disposed in some cases in all area other than the display pattern area of one or both glass substrates, the black mask film being electrically insulated from the display pattern electrodes by non-conductive material. The black mask film is made of a metal thin film of, e.g., chromium, molybdenum or the like. A resin film such as acrylic dispersed with pigment and carbon may be used as the black mask film.

As shown in FIG. 2C, an insulating film 41 and a black mask film 42 are formed, for example between the glass substrate 12 (13) and transparent electrode 31 of the liquid crystal cell. If necessary these films may be formed between the transparent electrode 31 and alignment film 32. It is preferable to use this light shielding structure for the liquid crystal display device particularly under color break-less FS driving.

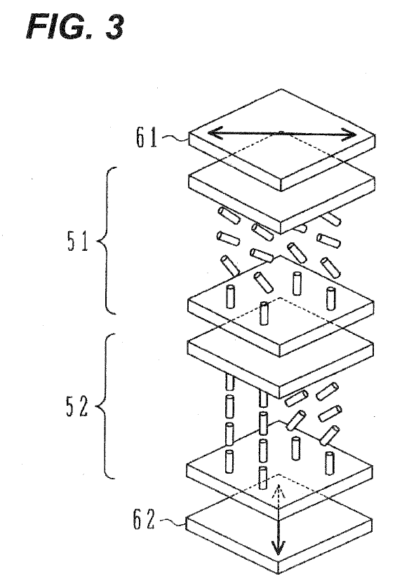

Next, with reference to FIG. 3, a two-layer TN mode liquid crystal display unit will be described. FIG. 3 is a schematic perspective view of a two-layer TN mode liquid crystal display unit. An upper polarizer 61 and a lower polarizer 62 are cross-Nicol disposed. The polarizers 61 and 62 may be made of SKN18243T manufactured by Polatechno Co., Ltd. Two liquid crystal cells 51 and 52 are disposed between the polarizers 61 and 62 in this order from the upper side.

The lower liquid crystal cell 52 is equivalent to the NWTN mode liquid crystal cell described with reference to FIG. 2A, and is operated as a “drive cell”. The drive cell 52 is used for switching bright/dark of the display unit by applying externally a drive voltage to this cell.

The upper liquid crystal cell 51 is used as a “compensation cell”. The rubbing direction is set so that liquid crystal molecules of the compensation cell 51 are aligned at right twist of 90° between upper and lower substrates. Chiral material inducing right twist is added to the liquid crystal layer of the compensation cell 51, and an alignment direction of molecules at the center of the liquid crystal layer in a thickness direction is set to a 3 o'clock direction. Display pattern electrodes are not formed on the surface of the glass substrate of the compensation cell 51. Other conditions are similar to those of the drive cell 52.

A retardation generated in the drive cell 52 is cancelled out by the compensation cell 51 so that a retardation becomes approximately 0 through front observation and dark display approximately equal to that by the cross-Nicol disposed polarizers can be obtained. By using a two-layer liquid crystal cell, normally black (NB) operation can be realized.

It is obvious that an optical film having similar optical characteristics to those of the compensation cell, e.g. a Twistar film manufactured by Polatechno Co., Ltd, can be used in place of the compensation cell. It has already been confirmed that similar operations are possible by applying the optical film to an actual liquid crystal display unit.

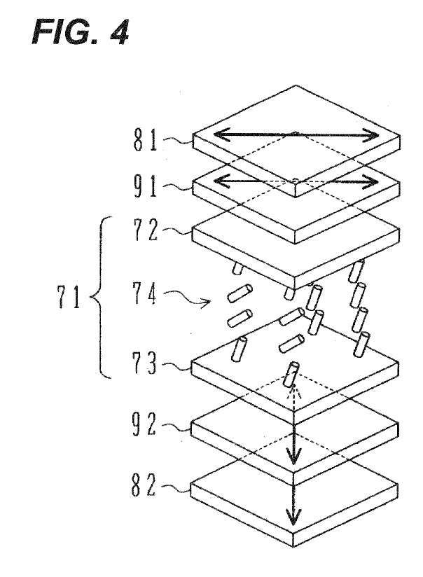

Next, with reference to FIG. 4, a vertical alignment (VA) mode liquid crystal display unit will be described. FIG. 4 is a schematic perspective view of a VA mode liquid crystal display unit. A transparent electrode having a desired pattern is disposed on the inner surface of each of upper and lower glass substrates 72 and 73 of a liquid crystal cell 71 of the VA mode liquid crystal display unit, and a vertical alignment film is formed on the transparent electrode. Upper and lower vertical alignment films are subjected to a rubbing process to align liquid crystal molecules antiparallel between upper and lower substrates.

A liquid crystal layer 74 is formed by making a space between the upper and lower vertical alignment films be filled with liquid crystal material of Δε<0. A thickness of the liquid crystal layer 74 is set to about 2 μm, a retardation Δnd is set to about 300 nm, and an alignment direction of molecules at the center of the liquid crystal layer in a thickness direction is set to a 12 o'clock direction.

The liquid crystal cell 71 is disposed between an upper polarizer 81 and a lower polarizer 82 cross-Nicol disposed. An absorption axis of the upper polarizer 81 is set at a position rotated counter clockwise by 45° from a 12 o'clock direction.

Visual angle compensation plates 91 and 92 are disposed between the liquid crystal cell 71 and upper and lower polarizers 81 and 82. An optical film having a negative biaxial optical anisotropy may be used as the visual angle compensation plates 91 and 92. In the liquid crystal display unit manufactured as a sample, a polarizer bonded with a visual angle compensation plate was used which was formed by bonding an optical film having negative biaxial optical anisotropy to an iodine-containing polarizer manufactured by Sumitomo Chemical Co., Ltd.

In-plane lag axes of the visual angle compensation plates 91 and 92 are set approximately parallel to the transmission axes of adjacent polarizers 81 and 82, respectively. Each of the visual angle compensation plates 91 and 92 has an in-plane phase difference of about 45 nm and a phase difference in a thickness direction (in a thickness cross section) of about 120 nm.

The visual angle compensation plate having negative biaxial optical anisotropy may be disposed on one of the upper and lower surfaces of the liquid crystal cell. On the other surface a visual angle compensation plate having negative uniaxial optical anisotropy may be disposed. A phase difference (a total sum of differences if two optical films are used) in a thickness direction, as a parameter of the optical film, is preferably set to about a 0.5-fold to 1-fold of Δnd of the liquid crystal cell. An in-plane phase difference of the optical film having negative biaxial optical anisotropy is preferably set to about 30 nm to about 65 nm.

The two-layer TN unit and VA unit are normally black type units. By using the normally black type unit, it becomes easy to manufacture a color break-less FD driving liquid crystal display device having a high contrast, with the structure not using a black mask. The VA unit is most suitable when considering visual angle characteristics. It has been confirmed that if a VA unit is used for operating an FS driving liquid crystal display device, overwhelmingly good display quality can be realized.

Next, description will be made on measurement results of electrooptical response characteristics at a room temperature, of liquid crystal display devices of three types: an NWTN mode, a two-layer TN mode and a VA mode manufactured in the manner described above. LCD5200 manufactured by Otuka Electronics Co., Ltd was used for measurements.

Drive conditions will be described. A drive waveform was rectangular, and a drive frequency was 500 Hz. An off-voltage of a drive voltage was set to 0V, and an on-voltage was set to 6 V for the NWTN unit, 5 V for the two-layer TN unit, and 6.5 V for the VA unit. The on-voltage was set aiming at the conditions that a transmissivity of the NWTN unit became about 1% at the on-voltage and a transmissivity of the two-layer TN unit and VA unit became about 25% at the on-voltage.

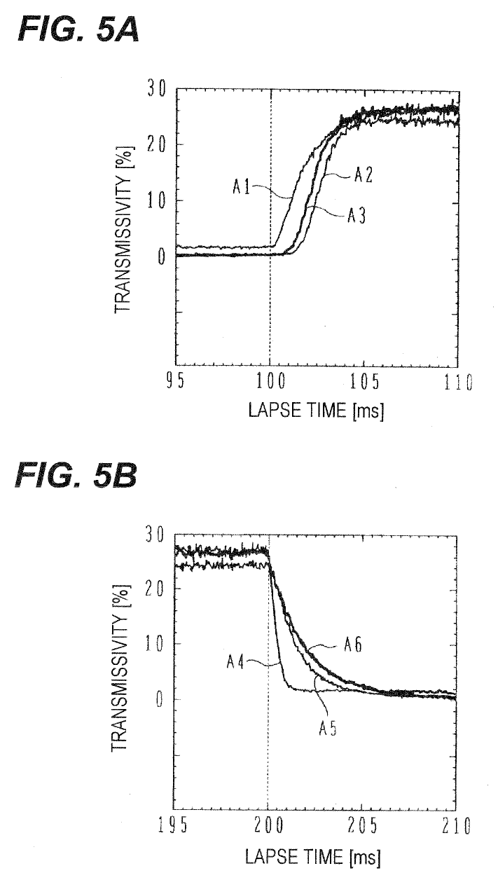

FIGS. 5A and 5B show measurement results of transient response waveforms of electrooptical responses at switching from dark display to bright display and at switching from bright display to dark display, respectively. The abscissa represents a lapse time, and the ordinate represents a transmissivity. Curves A1 to A3 shown in FIG. 5A indicate measurement results of the NWTN unit, two-layer TN unit and VA unit, respectively, and curves A4 to A6 shown in FIG. 5B indicate measurement results of the NWTN unit, two-layer TN unit and VA unit, respectively.

In changing dark display to bright display, the on-voltage is switched to the off-voltage for the NWTN unit, whereas the off-voltage is switched to the on-voltage for the two-layer TN unit and VA unit, i.e., normally black units. Electrically reversed switching is performed to change bright display to dark display.

In each type of the units, a response at switching from dark display to bright display is called a rise response, and a response at switching from bright display to dark display is called a fall response.

As shown in FIG. 5A, rise electrical switching was performed at a time 100 ms. In each type of the units, a response lag exists immediately after switching, and a transmissivity will not change during this response lag period.

A rise in the transmissivity appears earliest at the NWTN unit. In contrast, the normally black units have a long time until the transmissivity rises. In order to evaluate the response lag, a response lag time of each unit was measured. The response lag time was defined as a time from when electrical switching is performed to when the transmissivity rises to 2%. The response lag time was 0.32 ms for the NWTN unit, 1.62 ms for the two-layer TN unit, and 1.26 ms for the VA unit.

As shown in FIG. 5B, fall electrical switching was performed at a time 200 ms. The transmissivity rose after a response lag in the rise response, whereas the transmissivity lowered generally without a response lag in the fall response.

The NWTN unit shows the steepest fall of the transmissivity, and has a higher response speed than that of the normally black type units. However, every liquid crystal display unit takes a long time of about several ms to complete a fall response. It is presumed that a relatively high speed response of the NWTN unit results from its electrical rise response and from influence of its relatively high on-voltage as compared to that of the two-layer TN unit.

Since the NWTN unit has a relatively short fall response time, the NWTN unit can have a backlight emission time in conventional FS driving longer than that of the normally black type unit.

As described earlier, the normally black type unit is suitable for, for example, color break-less FS driving with improved display quality. However, as compared to the NWTN unit, a fall response time is long and it is difficult to have a long backlight emission time in conventional FS driving.

It has been long desired to provide an FS driving method capable of having a long backlight emission time even if a normally black type liquid crystal display unit is used. If the driving method of this type exists, there are advantages such as an improved luminance of a display unit and low cost due to reduction in the number of components of a light source of a backlight.

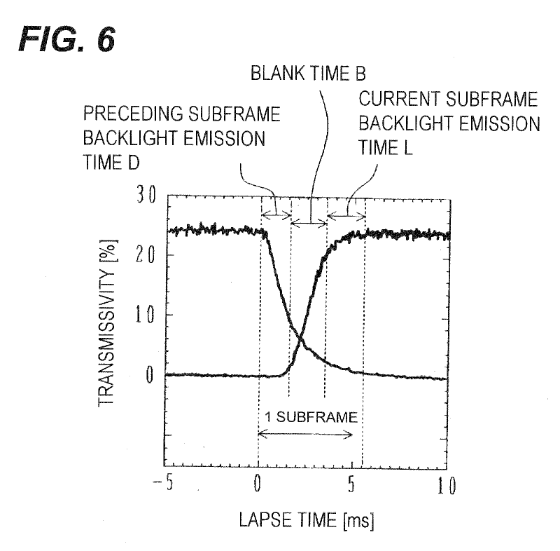

Next, the driving method of this type will be described with reference to FIG. 6. FIG. 6 is a graph showing rise/fall electrooptical transient response characteristics of a two-layer TN liquid crystal display unit in correspondence with one subframe timings. The ordinate represents a transmissivity, and the abscissa represents a lapse time as measured from a subframe start time of “0”.

Rise/fall electrical switching is performed at the subframe start time of “0”. As described above, although a fall response starts immediately after switching, a rise response (transmissivity rise) starts after a response lag. Since it takes a long time until a fall response is completed, a transmissivity of a fall response segment during the rise response lag time is not lowered sufficiently.

Therefore, if emission of the backlight corresponding to a subframe (preceding subframe) immediately before a subframe (current subframe) is prolonged to the rise response lag time, a luminance of a segment switched from bright display to dark display can be improved. On the other hand, since a transmissivity of the segment switched from dark display to bright display does not rise sufficiently as yet, optical leak can be suppressed and unnecessary color mixture can be suppressed.

As shown in FIG. 6, for example, a period from the start time of the current subframe to the rise response lag time can be set as a preceding subframe backlight emission time D during which the backlight corresponding to the preceding subframe is turned on.

After the preceding subframe backlight emission time D, a blank time B for extinguishing the backlight continues until the transmissivity of the fall response segment lowers sufficiently. After the blank time B, a current subframe backlight emission time L continues to turn on a backlight for the current subframe.

The normally black type liquid crystal display unit has a longer rise response lag time than that of the NWTN unit. Further, since the transmissivity of the normally black type lowers more gently in the fall response than the NWTN unit, a transmissivity during the rise response lag period is high. From this viewpoint, the FS driving method incorporating the preceding subframe backlight emission time is expected to be effective for improving a display luminance of particularly a normally black type liquid crystal display unit.

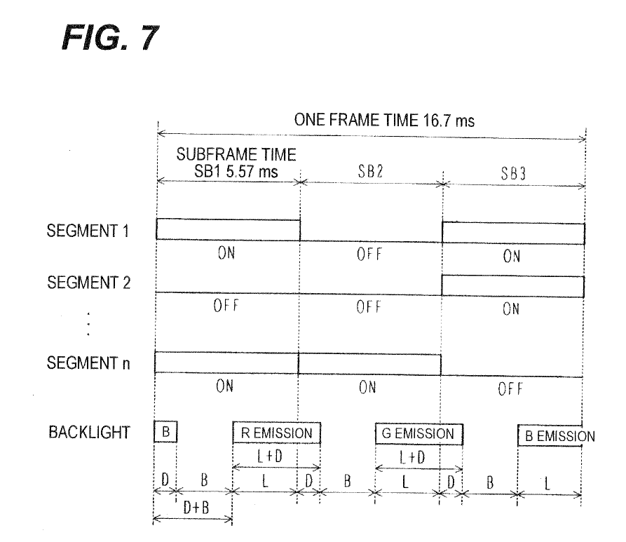

Next, with reference to FIG. 7, a FS driving method of the second embodiment will be described. In the second embodiment, the preceding subframe backlight emission time is incorporated in the normal FS driving. FIG. 7 is a timing chart showing timings of input signals to segment display units and backlight emission. A normally black type is assumed for the liquid crystal display unit. If a normally white type such as an NWTN unit is used as the liquid crystal display unit, on/off control of segments is reversed.

Three subframes SB1 to SB3 are set in one frame. Bright/dark display states of each segment are controlled to realize a display pattern corresponding to each subframe. R, G and B are set to emission colors corresponding to the display patterns of the subframes SB1 to SB3.

A backlight of emission color corresponding to the display pattern of each subframe is turned on during a current subframe backlight emission time L. The backlight of emission color corresponding to each subframe is continued to be turned on by prolonging by a preceding subframe backlight emission time D set to an initial period of a subframe immediately after the current subframe. An emission state during a total period of the current subframe backlight emission time L and preceding subframe backlight emission time D are repeated with a blank time B being interposed.

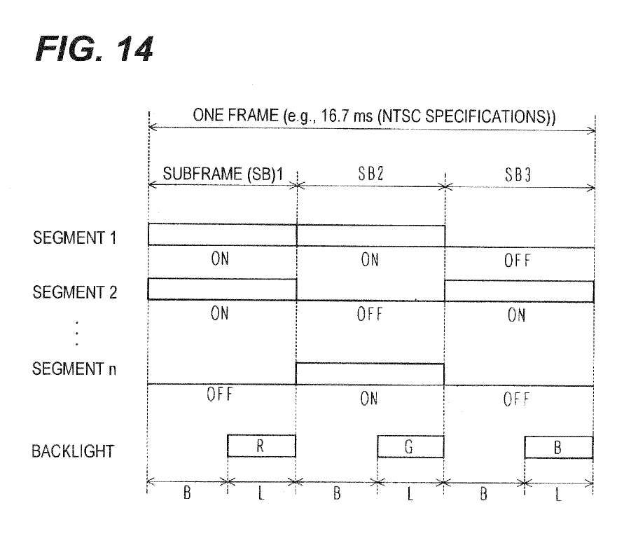

As described in the chapter “DESCRIPTION OF THE RELATED ART” of this specification with reference to FIG. 14, in the conventional normal FS driving method, a backlight turned on in one subframe is turned off at the end time of the subframe.

In contrast, in the driving method of the second embodiment, a backlight of emission color corresponding to a display pattern of one subframe continues to be turned on by prolonging to the subframe immediately after the current subframe, so that a display luminance can be improved.

For example, it is assumed that one frame time duration is 16.7 ms and each subframe time duration is 5.57 ms. If an NWTN unit is used as a liquid crystal display unit, for example, 0.32 ms is set to a preceding subframe backlight emission time, and 2.5 ms is set to a response standby time (emission standby time D+B) which is a standby time from a subframe start time to a backlight emission time of emission color corresponding to the current subframe. The current subframe backlight emission time L is 3.07 ms obtained by subtracting the response standby time from the subframe time.

An emission time of each of RGB is a total sum of the current subframe backlight emission time L and preceding subframe backlight emission time D, i.e., 3.39 ms. An emission time of each color in the conventional FS driving method is only the current subframe backlight emission time L of 3.07 ms. The embodiment driving method can realize therefore an emission time prolongation by about 10%.

If a two-layer TN unit is used as a liquid crystal display unit, for example, 1.62 ms is set to the preceding subframe backlight emission time D, and 3.5 ms is set to the response standby time. In this case, the current subframe backlight emission time L is 2.07 ms. An emission time per one color introducing the preceding subframe emission time is therefore prolonged to 3.69 ms which is an emission time prolongation of about 78% as compared to a conventional method emission time of 2.07 ms.

If a VA unit is used as a liquid crystal display unit, for example, 1.26 ms is set to the preceding subframe backlight emission time D, and 3.5 ms is set to the response standby time. In this case, the current subframe backlight emission time L is 2.07 ms. An emission time per one color introducing the preceding subframe emission time is therefore prolonged to 3.33 ms which is an emission time prolongation of about 61% as compared to a conventional method emission time of 2.07 ms.

As described above, an emission time can be prolonged particularly in the normally black type liquid crystal display units (two-layer TN unit and VA unit).

Visual states were observed by manufacturing normal FS driving liquid crystal display devices of three types adopting the above-described drive timings. It was visually confirmed that a display luminance of the liquid crystal display devices of all types was improved under the condition of the same backlight emission luminance, more than the devices driven by the conventional driving method. Although almost any difference of color purity from the conventional driving method was found, it was confirmed that a clearer display state was obtained because of an improved display luminance.

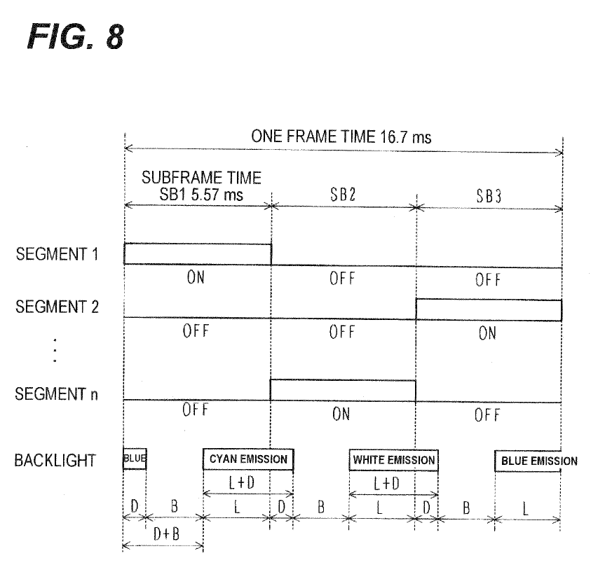

Next, with reference to FIG. 8, an FS driving method of the third embodiment will be described. In the third embodiment, the preceding subframe backlight emission time is incorporated in the color break-less FS driving method. FIG. 8 is a timing chart showing timings of input signals to segment display units and backlight emission. Similar to the second embodiment, a normally black type is assumed for the liquid crystal display unit.

Since the color break-less FS driving is performed in the third embodiment, only one subframe per frame is subjected to bright display in each segment. Further, since there is an emission state that a light source is turned on with a plurality of colors at the same time, emission color of mixture color such as cyan is obtained in a single subframe.

The preceding subframe backlight emission time D, blank time B and current subframe backlight emission time L are set in a maimer similar to the second embodiment. Since the preceding subframe backlight emission time is incorporated, a display luminance is improved more than the conventional method, also in the third embodiment using color break-less FS driving, similar to the second embodiment using normal FS driving.

As described above, a backlight emission time can be prolonged as compared to the conventional method by incorporating the preceding subframe backlight emission time in the FS driving method. Therefore, the display luminance can be improved, for example, without increasing a luminance of a backlight.

Incorporation of the preceding subframe backlight emission time is considered useful for luminance improving techniques particularly for a color break-less FS driving method by which a backlight is turned on only in one subframe even for mixture color display. This method may be applied to a case wherein a display luminance similar to the conventional method is ensured although a luminance of a backlight is lowered.

A display luminance can be improved while suppressing a reduction in color purity to be caused by unnecessary color mixture, by turning on a backlight of emission color corresponding to the display pattern of a preceding subframe during a period from a subframe start time to a fall response lag time of a liquid crystal display unit.

There is a tendency that a rise response lag time of a normally black type liquid crystal display unit is longer than that of a normally white type liquid crystal display unit, and that a transmissivity of the normally black type liquid crystal display unit lowers gentler than that of the normally white type liquid crystal display unit. From this reason, it can be considered that the FS driving method incorporating the preceding subframe backlight emission time is effective particularly for use with a normally black type liquid crystal display unit.

With a general FS driving method, bright display of a display unit in a subframe either remains to be bright display in a subframe immediately after the first-mentioned subframe or changes to dark display. With the normal FS driving method, there is a display state in mixture color display that bright display continues to be bright display in consecutive two subframes in one frame. On the other hand, with the color break-less FS driving method, since the display has bright display only in one subframe per frame, there is no display state that bright display continues to be bright display in one frame.

As the preceding subframe backlight emission time is incorporated, not only the luminance improvement effects are obtained for the display unit changing from bright display to dark display, but also the higher luminance improvement effects are obtained for the display unit changing from bright display to bright display, because the emission time prolongs maintaining the bright display.

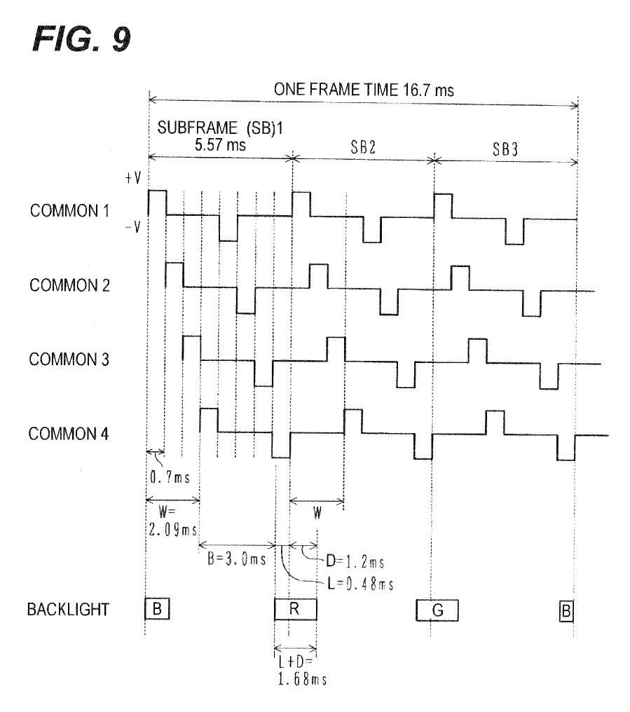

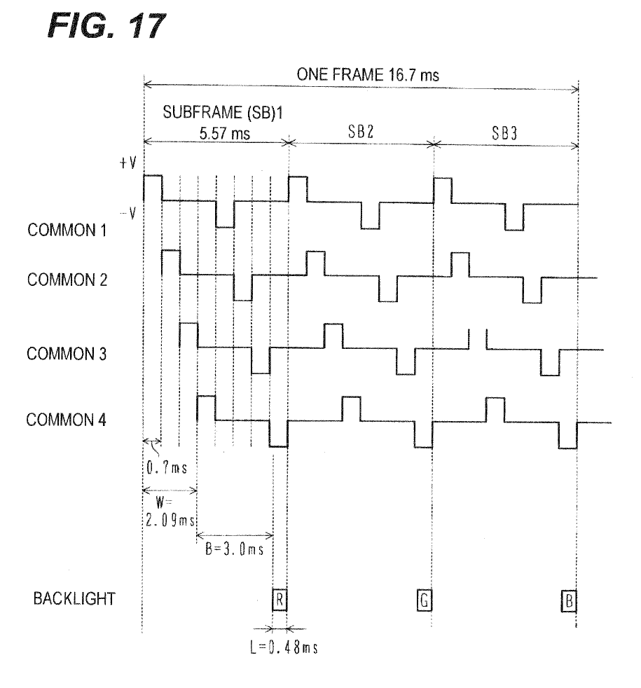

Next, with reference to FIG. 9, an FS driving method of the fourth embodiment will be described. In the fourth embodiment, the preceding subframe backlight emission time is incorporated in the normal FS driving method of multiplex driving. For comparison, a conventional FS driving method of multiplex driving will be described with reference to FIG. 17.

FIGS. 9 and 17 are timing charts showing timings of input signals to common (scan line) electrodes and backlight emission according to the fourth embodiment and conventional method. One frame is set to 16.7 ms, and is divided into three subframes SB1 to SB3 each having the same time duration of 5.57 ms. Description will be made by using multiplex driving at a ¼ duty and a ⅓ bias by way of example. Common drive waveforms for selecting scan lines at applied voltages of ±V were used, and a drive frequency was set to about 180 Hz.

First, the conventional method as a comparison example will be described. With the FS driving method of multiplex driving, since there are a plurality of scan lines, it is necessary to hold a backlight emission operation until completion of N−1 scans where N is the number of scan lines. This hold time is called a scan hold time W. The scan hold time W is defined as (1/f)×(N−1)/2N where f is a drive frequency.

In the example shown in FIG. 17, the scan hold time W is 2.09 ms. Thereafter, a blank time B for awaiting a response of the liquid crystal display unit is set starting from a time when a select voltage is applied to the last scan line. The blank time B is, e.g., 3.0 ms.

After the blank time B, a backlight emission time L continues to turn on a backlight of emission light corresponding to a current subframe. A backlight emission time L of one color can be obtained by subtracting the scan hold time W and blank time B from a subframe time, and is 0.48 ms. As the number of scan lines becomes large, the scan hold time W becomes long so that a display luminance of the liquid crystal display device becomes lower.

On the other hand, as shown in FIG. 9, the driving method of the fourth embodiment incorporates a preceding subframe backlight emission time D in each subframe, as compared to the driving method of the comparative example. In this example shown in FIG. 9, the preceding subframe backlight emission time D is set to 1.2 ms. Therefore, the backlight emission time per color is prolonged by 1.2 ms from 0.48 ms of the comparative example, to reach 1.68 ms which is about a threefold of the comparative example and provides a greatly improved luminance. The scan hold time is used effectively for improving the display luminance.

The FS driving method incorporating the preceding subframe backlight emission time is effective also for a case in which it becomes difficult to ensure a backlight emission time in a current subframe because the scan hold time becomes long due to multiplex driving.

Visual states were compared by manufacturing a liquid crystal display device using a two-layer TN unit as a liquid crystal unit and driving the device by drive sequences shown in FIGS. 9 and 17.

Although multiplex driving at the ¼ duty has been described by way of example, it is already known that a proper duty ratio is about ½ duty to ⅛ duty. A multiplex driving frequency is preferably 150 Hz to 1 kHz, and more preferably 300 Hz to 1 kHz.

In the above embodiments, although the number of subframes is set to “3”, the number of subframes is not limited to “3”. It is sufficient if the number of subframes is 2 or more particularly for the color break-less FS driving method. Also in the above embodiments, although each subframe time is set equal, the subframes are not limited to the same time duration. For example, a subframe time may be changed to obtain a desired display luminance balance of emission colors. It is also possible to change the preceding subframe backlight emission time D, blank time B and current subframe backlight emission time L for each subframe.

Next, description will be made on the conditions required to be satisfied by parameters of the FS driving method incorporating the preceding subframe backlight emission time. A frame time is represented by F, a subframe number is represented by M, a subframe time is represented by Sm (m=1 to M), a preceding subframe backlight time is represented by Dm (m=1 to M), a blank time is represented by Bm (m=1 to M), a current subframe backlight emission time is represented by Lm (m=1 to M), and a scan hold time is represented by W.

The first condition will be described. The frame time F is given by:

$$F = {\sum }_{m = 1}^{M} Sm$$

If each subframe has an equal time duration, the frame time is given by:

F=S×M

where S is a subframe time.

Next, the second condition will be described. If the scan hold time W is not longer than the preceding subframe backlight emission time Dm (W≦Dm), the following equation is satisfied:

Sm=Dm+Bm+Lm

If the scan hold time W is not shorter than the preceding subframe backlight emission time Dm (W≧Dm), the following equation is satisfied:

Sm=Dm+(W−Dm)+Bm+Lm

Since the number N of scan lines is “1” for static driving, the scan hold time is W=0.

A backlight emission time is ensured for both the cases of (W≦Dm) and (W≧Dm), if the preceding subframe backlight time Dm is not 0 even if the current subframe backlight emission time Lm is 0.

Even if the current subframe backlight emission time Lm is not 0 or is 0, a backlight of emission light corresponding to a display pattern of an arbitrary subframe is turned on during a period from some timing in the subframe to some timing in the subframe immediately thereafter.

Next, the third condition will be described. A rise or fall response time of liquid crystal is preferably not longer than the shortest subframe time Sm and more preferably not shorter than the shortest Sm−W.

A rise response time and a fall response time are defined in the following manner. Consider now a relative transmissivity that a transmissivity in a steady state upon application of a dark display voltage is 0% and a transmissivity in a steady state upon application of a bright display voltage is 100%. The rise response time is defined as a time required for the relative transmissivity to rise from 0% to 90% in an optical response from dark display to bright display. The fall response time is defined as a time required for the relative transmissivity to fall from 100% to 10% in an optical response from bright display to dark display.

An FS driving liquid crystal display device can be manufactured under the above-described conditions, which device can provide good color purity irrespective of a response speed of the liquid crystal display unit.

Next, description will be made on an FS driving method considering temperature dependency of a liquid crystal display unit upon electrooptical response. Description will be made first on temperature dependency of an NWTN unit, a two-layer TN unit and a VA unit, upon electrooptical response.

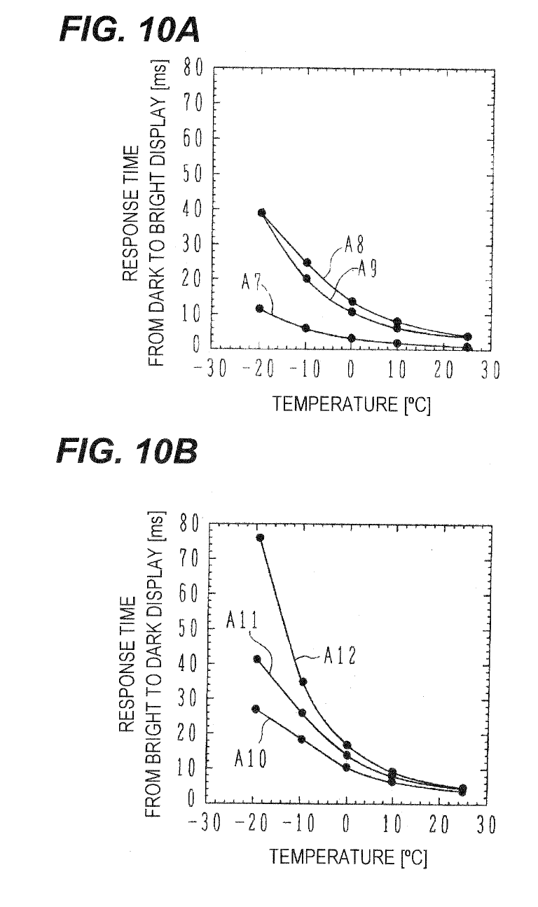

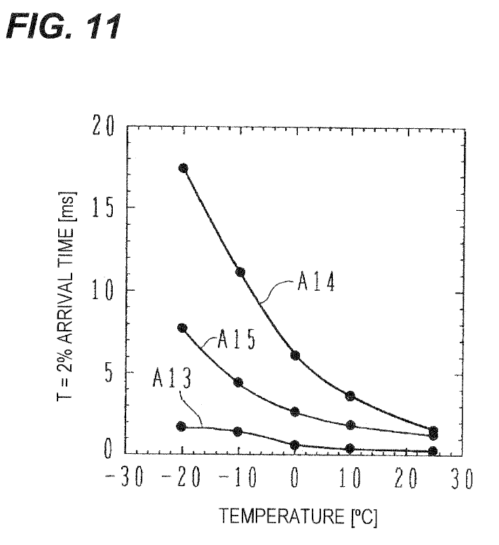

FIGS. 10A, 10B and 11 are graphs showing temperature dependency of rise response time, fall response time and rise response lag time, respectively. The abscissa represents a temperature and the ordinate represents a time. Curves A7 to A9 in FIG. 10A, curves A10 to A12 of FIG. 10B and curves A13 to A15 of FIG. 11 indicate temperature dependency of the NWTN unit, two-layer TN unit and AV unit, respectively.

As described above, the rise response time is defined as a time required for the relative transmissivity to rise from 0% to 90%, whereas the fall response time is defined as a time required for the relative transmissivity to fall from 100% to 10%. The rise response lag time is a time required for an (absolute) transmissivity to rise from electrical switching by 2%.

As a temperature lowers, the rise response time, fall response time and rise response lag time become long for all three types of devices. There is a tendency that a change with temperature of the normally black type unit is larger than that of the NWTN unit. A response time of the NWTN element shorter than that of the normally black type unit has been described with reference to FIGS. 5A and 5B. There is a tendency that the more the temperature lowers, the more a difference between the NWTN unit and normally black type unit expands.

The rise response time of the two-layer TN unit and VA unit has approximately a similar change with temperature, the fall response time of the VA unit has a large change with temperature than that of the two-layer TN unit, and the rise response lag time of the two-layer TN unit has a larger change with temperature than that of the VA unit.

As described above, the more a temperature lowers, an electrooptical response of a liquid crystal display unit becomes slower. In a conventional FS driving liquid crystal display device, as the response time becomes long, a backlight emission time (corresponding to the current subframe backlight emission time of the embodiment) becomes short and a luminance lowers. Moreover, as the response standby time prolongs to the subframe end time, the backlight cannot be turned on (corresponding to a current subframe backlight emission time of “0” in the embodiment). Because of this, a display state as intended cannot be realized and a color display itself cannot be made.

As described with the second embodiment, a backlight emission time is ensured by the introduced preceding subframe backup emission time, even if the current subframe backlight emission time becomes “0”. Namely, a desired display state can be realized by turning on a backlight of emission color corresponding to the display pattern of a current subframe, in a subframe immediately after the current subframe. The FS driving method incorporating the preceding subframe backlight emission time is therefore effective for a case in which a response time of liquid crystal is slow such as at a low temperature.

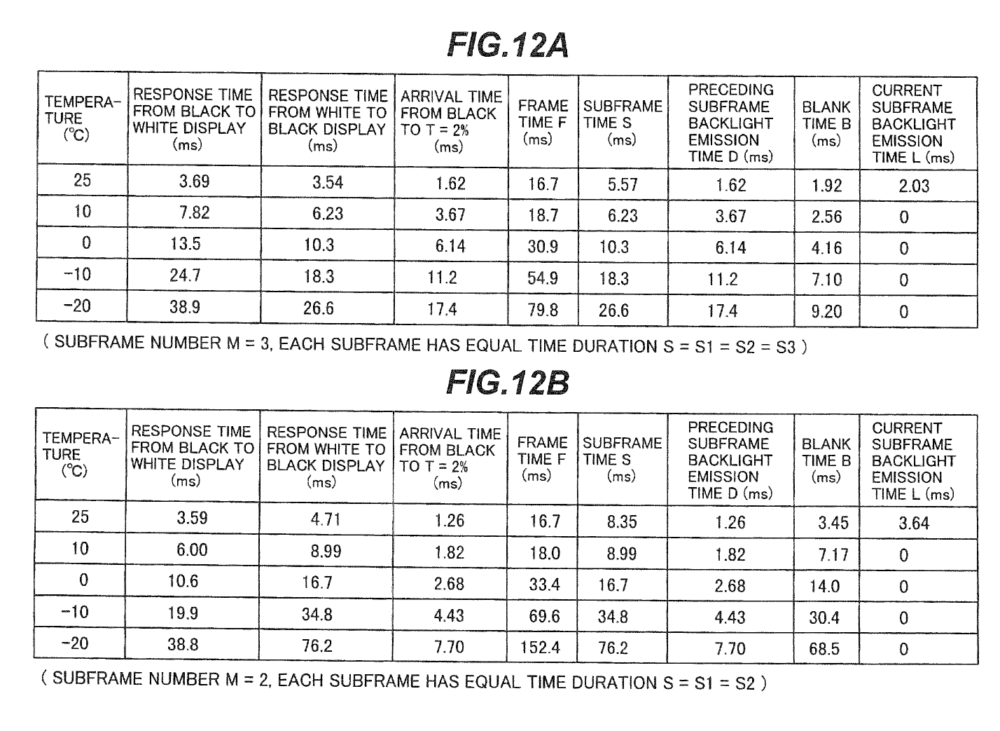

Next, with reference to FIG. 12A, description will be made on an FS driving method of the fifth embodiment in which drive parameters such as a subframe time is changed with a temperature In the fifth embodiment, a two-layer TN unit of static driving is used as a liquid crystal display unit. Since the number N of scan lines is “1”, a scan hold tome is W=0. In the fifth embodiment, drive parameters for determining the FS driving condition are changed with temperature. FIG. 12A is a table showing a list of drive parameters according to the fifth embodiment.

The table describes in the unit of ms a rise response time (response time from black to white display), a fall response time (response time from white to black display), a rise response lag time (arrival time from black to T=2%), a frame time F, a subframe time S, a preceding subframe backlight emission time D, a blank time B and a current subframe backlight emission time L, respectively at temperatures of 25° C., 10° C., 0° C., −10° C. and −20° C. The number M of subframes is set to “3” and each subframe has an equal time duration.

At a temperature not higher than 10° C., the subframe time S is set equal to the fall response time, and the current subframe backlight emission time L is set to 0 ms. At all temperatures, the preceding subframe backlight emission time D is set equal to the rise response lag time.

A sum or the preceding subframe backlight emission time D, blank time B and current subframe backlight emission time L is equal to the subframe time S. At a temperature not higher than 10° C., a sum of the preceding subframe backlight emission time D and blank time B is equal to the subframe time S and fall response time. Since the subframe time S is set equal to the fall response time at a temperature not higher than 10° C., the subframe time S and frame time F become long as the temperature lowers.

The subframe time S is preferably set to a time duration not shorter than the fall response time of a liquid crystal display unit. However, if the subframe time is too long, it is difficult to obtain good color display. It is therefore effective for obtaining good color display to set the subframe time S (more preferably the subframe time S−scan hold time W) equal to the fall response time of a liquid crystal display unit at a low temperature.

In this case, since the fall response reaches the subframe end, the current subframe backlight emission time L becomes “0”. The preceding subframe backlight emission time D is incorporated in order to turn on a backlight of emission color corresponding to the display pattern of the current subframe in the subframe immediately thereafter.

Visual states were observed by operating the liquid crystal display device adopting such drive parameters and immersed into a constant temperature bath. Drive parameters were changed manually in accordance with a temperature of the constant temperature bath. Although there was a phenomenon that as the temperature lowered, display flicker became heavy, it was confirmed that display color as intended was obtained.

Next, with reference to FIG. 12B, an FS driving method of the sixth embodiment will be described. In the sixth embodiment, a VA unit of static driving is used as a liquid crystal display unit. Similar to the fifth embodiment, a scan hold time is W=0. Also in the sixth embodiment, drive parameters are changed with a temperature similar to the fifth embodiment. FIG. 12B is a table showing a list of drive parameters according to the sixth embodiment.

A relation among parameters is similar to that of the fifth embodiment. However, the number M of subframes is set to “2” and each subframe has an equal time duration. Also in the liquid crystal display device of the sixth embodiment, as a temperature lowers, the subframe time S and frame time T become long. Visual states were observed by operating the liquid crystal display device immersed into a constant temperature bath, similar to the liquid crystal display device of the fifth embodiment using the two-layer TN unit. Similar to the liquid crystal display device of the fifth embodiment, there was a phenomenon that as the temperature lowered, display flicker became heavy. Further, although there was a phenomenon that a luminance of a display unit lowered, display color as intended was obtained.

The preceding subframe backlight emission time is not necessarily required to be set from the start time of a subframe. Unnecessary color mixture can be suppressed and a display luminance can be improved, if a backlight of emission color corresponding to the display pattern of the preceding pattern is turned on during the rise response lag time of the liquid crystal display unit.

Although the drive parameters suitable for a temperature have been set manually in the fifth and sixth embodiments, a liquid crystal display device may be structured in such a manner that drive parameters can be set automatically, as will be described in the following.

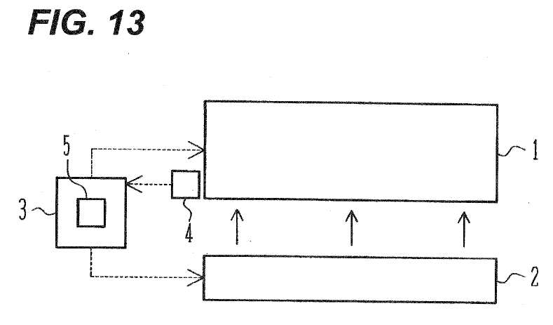

FIG. 13 is a schematic diagram showing a liquid crystal display device of the seventh embodiment. The liquid crystal display device has a temperature sensor 4 for measuring a temperature of a liquid crystal display unit 1, disposed near or on the surface of the liquid crystal display unit 1 or in a liquid crystal cell. Temperature data measured with the temperature sensor 4 is input to a drive unit 3.

In the seventh embodiment, temperature dependency of the liquid crystal display unit 1 upon electrooptical response characteristics is measured in advance, and drive parameters at each temperature are determined in accordance with the measured temperature dependency, for example, similar to the tables shown in FIGS. 12A and 12B. The drive parameters are stored in a memory 5 of the drive unit 3, e.g., at a pitch of 1° C.

In accordance with temperature data input from the temperature sensor 4, the drive unit reads parameters corresponding to the temperature from the memory 5, and synchronously drives the multicolor backlight 2 and liquid crystal display unit 1. The liquid crystal display device can thus be realized which can automatically select drive parameters suitable for each temperature even if an environmental temperature changes.

Drive parameters suitable for a temperature may be set by making a frequency oscillator unit variable in an analog way. If the drive unit has one frequency oscillator unit which has a circuit structure which determines LC components and a backlight operation timing, an operation is ensured to some degree by changing only the frequency of the oscillator unit with temperature.

As described above, even if the electrooptical response of a liquid crystal display unit becomes slow as the temperature lowers, good FS driving can be performed by setting drive parameters such as a subframe time and a preceding subframe backlight emission time in accordance with the lowered temperature.

For example, even if a response time becomes long at a low temperature and a backlight of emission color corresponding to the display pattern of the subframe cannot be turned on, the backlight of the emission color is turned on at the initial stage of the subframe immediately thereafter so that a desired display state can be obtained.

For example, if a time duration of one subframe is around 5.57 ms and a fall response time is 5.57 ms or longer it can be said that a preferable drive mode is not to turn on the backlight of emission color corresponding to the subframe during the subframe but to turn on the backlight in the subframe immediately thereafter. This drive mode is particularly preferable, e.g., at a temperature of −10° C. to −30° C.

It can be said that a drive mode to turn on a backlight of emission color corresponding to a subframe in the subframe and continue to be turned on by prolonging the emission period to the subframe immediately thereafter, is particularly preferable, e.g., for a case in which a fall response time is shorter than 5.57 ms. This drive mode is particularly preferable at a temperature not lower than a room temperature, e.g., +15° C. to +95° C.

In the above embodiment, although the rise response lag time is defined as a time when the absolute transmissivity rises by 2%, the rise response lag time is generally preferable if it is defined by using a relative transmissivity. A absolute transmissivity of 2% corresponds to a relative transmissivity of 10%. Therefore, the rise response lag time is defined by a time from electrical switching to a time when the relative transmissivity rises by 10%

The liquid crystal display device and FS driving method of the embodiments are applicable to the following products. The products include a vehicle mounted information display device including a segment display unit or a segment display unit and a dot matrix display unit, a display unit of a car audio apparatus, an operation panel display unit of a copy machine or the like, and all types of information display apparatus (including a thin film transistor liquid crystal display device).

The present invention has been described in connection with the embodiments. The present invention is not limited only to the embodiments. For example, it is obvious that those skilled in the art can make various modifications, improvements, combinations and the like.

What are claimed are:

1. A liquid crystal display device comprising:
a liquid crystal display unit including a plurality of display units each switching between bright display and dark display;
a backlight having a light source of a plurality of colors for making light emitted from said light source be incident upon said liquid crystal display unit; and
a drive unit for performing field sequential driving through synchronization of said liquid crystal display unit and said backlight,
wherein said drive unit controls a state of bright/dark display of said liquid crystal display unit to realize a display pattern corresponding to each subframe obtained by dividing a frame into a plurality of subframes, and controls an emission state of said backlight to turn on said backlight of emission color corresponding to a display pattern of an arbitrary first subframe from some timing in said first subframe to some timing in a second subframe immediately after said first subframe.

2. The liquid crystal display device according to claim 1, wherein said drive unit controls the emission state of said backlight to turn on said backlight of emission color corresponding to a display pattern of said first subframe in said first subframe and continue to be turned on being prolonged into said second subframe.

3. The liquid crystal display device according to claim 1, wherein said drive unit controls the emission state of said backlight not to turn on said backlight of emission color corresponding to a display pattern of said first subframe in said first subframe but to turn on said backlight in said second subframe.

4. The liquid crystal display device according to claim 17 wherein said drive unit turns of said light source of emission color corresponding to the display pattern of said first subframe during a period from a start time of said second subframe to a rise response lag time from dark display to bright display of said liquid crystal display unit.

5. The liquid crystal display device according to claim 1, wherein a response time from dark display to bright display or from bright display to dark display of said liquid crystal display unit is not longer than a shortest subframe time Sm.

6 The liquid crystal display device according to claim 1, wherein said liquid crystal display unit is a normally black type.

7. The liquid crystal display device according to claim 1, wherein said drive unit performs color break-less field sequential driving by controlling said liquid crystal display unit in such a manner that in some display unit dark display is effected only in one subframe per frame and by controlling said backlight in such a manner that said light source is turned on with a plurality of colors at the same time in some subframe.

8. The liquid crystal display device according to claim 1, wherein:
said liquid crystal display unit has a plurality of scan lines under multiplex driving; and
said drive unit drives said liquid crystal display unit under drive conditions of a duty ratio of a ½ duty to a ⅛ duty and a drive frequency of 150 Hz to 1 kHz.

9. The liquid crystal display device according to claim 1, further comprising:
a temperature sensor for measuring a temperature of said liquid crystal display unit;
wherein said drive unit stores drive parameters at each temperature including a subframe time and an emission time, inn said second subframe, of emission color corresponding to the display pattern of said first subframe, reads said drive parameters corresponding to a temperature measured with said temperature sensor, and controls said liquid crystal display unit and said backlight in accordance with said read drive parameters.
